(19) United States
(12) Patent Application Publication
(10) Pub. No.: US 2026/0105424 A1
(43) Pub. Date: Apr. 16, 2026

(54) SMARTPHONE INCORPORATING A HARDWARE WALLET FOR STORING CRYPTOGRAPHIC KEYS IMPLEMENTING HARDWARE MULTIPLEXING OF THE SMARTPHONE'S DISPLAY

(71) Applicant: LEDGER, Paris (FR)

(72) Inventors: Patrice Emmanuel Denis HAMEAU, Bourg-la-Reine (FR); Philippe THIERRY, Palaiseau (FR); Charles GUILLEMET, La Tronche (FR); Christian KALUZA, Tullins (FR)

(21) Appl. No.: 19/116,984

(22) PCT Filed: Sep. 25, 2023
(86) PCT No.: PCT/FR2023/051470

§ 371 Date: Mar. 28, 2025

(30) Foreign Application Priority Data
Sep. 30, 2022 (FR) FR2209984
Sep. 30, 2022 (FR) FR2209987
Nov. 29, 2022 (FR) FR2212475
May 17, 2023 (FR) FR2304933

(51) Int. Cl. G06Q 20/06; G06F 21/85; G06Q 20/32

(52) U.S. Cl. CPC G06Q 20/065; G06F 21/85; G06Q 20/3227

(57) ABSTRACT

Connected terminal comprising an application processor (APP PROC) having a first display controller (DC3) connected to a display interface bus (MIPI DSI), and a display (DISP) connected to the display interface bus (MIPI DSI). The terminal comprises a device (DHW) interposed on the display interface bus (MIPI DSI), forming an embedded hardware wallet, and comprising a secure element (eSE), a second display controller (DC4) controlled by the secure element, and a multiplexer (MUX) controlled by the secure element and comprising a first input connected to an output of the first display controller (DC3) via the display interface bus (MIPI DSI), a second input connected to an output of the second display controller (DC4), and an output connected to the display (DISP) via the display interface bus (MIPI DSI).

### CROSS-REFERENCE TO RELATED APPLICATIONS

This application is a 371 National Stage of International Application No. PCT/FR2023/051470, filed Sep. 25, 2023, which claims priority to French Patent Application No. FR2209987, filed Sep. 30, 2022, French Patent Application No. FR2209984, filed Sep. 30, 2022, French Patent Application No. FR2212475, filed Nov. 29, 2022, and French Patent Application No. FR2304933, filed May 17, 2023, the disclosures of which are herein incorporated by reference in their entirety.

### TECHNICAL FIELD

The present disclosure relates to secure portable devices for storing and implementing private cryptographic keys in an isolated manner with respect to a network (“cold” storage), particularly keys allowing transactions to be performed on a blockchain.

### BACKGROUND

In recent years, the development of cryptocurrencies or other types of cryptoassets managed by the blockchain, such as non-fungible tokens (NFTs) and Smart Contracts, has given rise to various ways of storing and holding the private keys attached to these different types of cryptoassets. This is how the notions of “wallet”, “cold storage” and “hot storage” of private keys appeared. A “wallet” is a device or program whose function is to manage cryptoassets, and therefore to store the private keys attached to them. So-called “hot wallets” are connected to the Internet and are exposed to hacker attacks or to viruses and malware. These can be wallets managed by centralized exchanges, which do not offer the highest level of security. Thus, many centralized platforms have been pillaged hundreds of millions of dollars by hackers over the years. “Hot” wallets can also take the form of programs installed on mobile phones, tablets or personal computers (“software wallets”). Such wallets are permanently connected to the internet and integrate many unsecured applications, and are therefore themselves exposed to attacks.

Cold wallets are the most secure solution for cold storage of private keys, i.e. removed from direct access to the internet, which reduces the attack exposure and thus the risk of theft by hacking. Transactions involving private keys are signed in an offline environment. Any transaction initiated online is temporarily transferred to the offline hardware wallet, where it is then digitally signed before being transmitted to the online network. Since the private key is not communicated to the online server during the signing process, a hacker cannot access it.

The simplest form of cold storage is passive storage. A passive wallet may be a document or an image file on which the user's public and private keys are written. The passive storage usually has an incorporated QR code that can be scanned to sign a transaction. The disadvantage of this medium is that if the passive storage is lost, illegible, or destroyed, the user can no longer access their funds.

Hardware wallets are a convenient alternative to passive wallets for storing private keys. In addition, they are usually configured to generate recovery phrases to restore private keys if they are lost. Note that cryptoassets are never stored in a hardware wallet but are recorded on the blockchain. The hardware wallet only stores the private keys to manage transactions on the blockchain. The public keys corresponding to private keys point to an address on the blockchain where the assets are effectively located.

As shown in FIG. 1, a hardware wallet HW is never directly connected to the internet. To be usable, the hardware wallet HW must be connected to a host device HDV via a data link LNK, e.g. USB or Bluetooth. The host device HDV may be a computer, a mobile phone or a tablet, and runs so-called “companion” software for conducting transactions on the blockchain BCN, such as the “Ledger Live” software developed by the applicant. Alternatively, the hardware wallet HW may be used, through the HDV host device, with decentralized exchanges or DEXs, where the user can transact while keeping their keys in the hardware wallet.

The hardware wallets HW marketed by the applicant have been commercially successful because of the high degree of security they offer, through the use of a “secure element” to store private keys and sign transactions. A secure element is a hardware platform that can store and manipulate data in compliance with the security rules and requirements set by a trusted authority. It comes in the form of a semiconductor chip that implements various countermeasures against fraudster attacks.

FIG. 2 shows the architecture of a hardware wallet HW1 marketed by the applicant as the “Nano S”, described in more detail in the document https://developers.ledger.com/docs/nano-app/bolos-hardware-architecture/. The hardware wallet HW1 features a secure element SE1 paired with a microcontroller MCU1. The processor MCU1 has a USB interface U1 and acts as a proxy device for the secure element SE1, for communication with an external host device HDV running a companion application (see FIG. 1). The secure element SE1 has its own Secure Operating System OS (firmware) that allows it to run application programs, and incorporates a cryptographic coprocessor CRY. The hardware wallet HW1 also features a display DISP1 and two buttons B1, B2, managed by the microcontroller MCU1. These two buttons play an important role in securing certain operations: the user must press both buttons at the same time to demonstrate their agreement or consent for performing or completing the operations.

Hardware wallets as described above are generally detached portable devices that are temporarily connected to a “connected” host device, such as a mobile terminal or smartphone, when performing a transaction. The detached nature of these hardware wallets offers a superior degree of security because they are mostly inaccessible via public networks, and thus little exposed to attacks. However, this characteristic makes these hardware wallets less ergonomic and inclined to being misplaced or forgotten.

Blockchain smartphones are known, which are designed to securely store certain virtual assets like cryptocurrencies and have an internal storage space inaccessible by the Internet to constitute a cold wallet: Samsung's® Galaxy S10 model, HTC's® Exodus 1 model, or Sirin Labs'® Finney model. These smartphones are equipped with an embedded secure element (designated eSE) which is a chip specially designed to store sensitive data and share it only with authorized applications and persons.

In terms of cryptocurrency, a very high degree of security is required. The blockchain smartphones described above offer a certain degree of security through the use of a secure enclave or trusted execution environment TEE, but the digital hardware wallet function, which is not the primary function of such a phone, requires more. Indeed, implementing a hardware wallet inside a smartphone partially removes the security advantages of a detached hardware wallet that is only connected when needed. This inevitably increases the wallet's exposure to Internet attacks.

There is therefore a need to provide a portable electronic device connected to the Internet allowing the execution of a transaction on the blockchain and, in particular, capable of executing an application designed to perform transactions on the blockchain, such as the Ledger Live application or equivalent, while offering a high degree of security regarding the preservation of secret keys of crypto asset accounts used for signing transactions.

Such a connected portable electronic device will necessarily include an application processor connectable to the Internet, capable of executing the application designed to perform transactions on the blockchain, for example Ledger Live, and comprising a display managed by the application processor to present transaction-related information to the user. For such a device to offer a high degree of security, it may be desirable that information presented to the user during the execution of a transaction cannot be falsified by a fraudulent program having taken control of the application processor.

Document WO2015124088A1 describes a mobile terminal comprising a secure transaction system equipped with a secure display unit and a physical confirmation button, so that when the mobile terminal displays sensitive information in the electronic transaction process, the sensitive information is displayed separately on the secure display unit. A separate physical confirmation button is used as a secure element unit, so that key transaction data can be achieved via the secure element and its secure display unit and its physical confirmation button without going through the general operating system in the mobile terminal.

Document WO2015180581 teaches display sharing between a main chip and a security chip using a switching module controlled by a button (FIG. 3). The switching module receives display data and applies them to a display driver that controls a display screen. In such a mixed architecture where multiple processors share access to a display screen, the display driver arranged at the output of the switching module is susceptible to attacks aimed at controlling the display. Moreover, in practice each processor must be able to address control signals to the display driver, requiring the provision of hardware connections such as conductive tracks. Such hardware connections increase the attack surface (also called exposure surface) of the mixed architecture and particularly the attack surface of the security chip.

Document EP 2 836 968 B1 describes a transaction device comprising a display, an unsecured processor, a secure processor including an image processor, and a mixer interposed between the display on one side and the unsecured processor and the image processor of the secure processor on the other side. The mixer is controlled by the secure processor and allows, in a secure operating mode of the device, the selection of images provided by the secure processor to ensure that the operating system of the unsecured processor no longer has control of the display.

The document “Trusted display and input using screen overlays” of Dec. 4, 2017, BRANDON ANTHONY ET AL: 2017 International Conference on Reconfigurable Computing and FPGAS (RECONFIG), IEEE, pages 1-6, DOI: 10.1109/RECONFIG.2017.8279826, describes a device comprising a display, an unsecured processor, a secure processor, and an FPGA circuit interposed between the display on one side and the unsecured processor and the secure processor on the other side. The FPGA circuit is controlled by the secure processor and allows, in a secure operating mode of the device, the selection of images provided by the secure processor to ensure that the unsecured processor no longer has control of the display.

Document US2021/026983 A1 describes an electronic terminal comprising a processor connected to a secure element by a wired bus. A switch allowing physical disconnection of the link between the processor and the secure element is provided.

There is therefore also a need to improve the security of mixed architectures in which multiple processors share access to a display screen.

There is also a need to integrate a hardware wallet into a conventional mobile terminal platform to transform it into a mobile terminal with an embedded hardware wallet, with minimal modifications to the mobile terminal platform.

### SUMMARY

Embodiments concern a connected terminal comprising an application processor having a first display controller connected to a display interface bus carrying display data formatted according to a display interface bus protocol, and a display connected to the display interface bus and designed to receive display data formatted according to said protocol. The terminal also includes a device interposed on the display interface bus, the device comprising a secure element connected to the application processor by a secure wired bus, a second display controller exclusively controlled by the secure element, designed to provide display data formatted according to said protocol, and a multiplexer controlled by the secure element and comprising a first input connected to an output of the first display controller via the display interface bus, a second input connected to an output of the second display controller, and an output connected to the display via the display interface bus, the multiplexer output providing display data formatted according to said protocol to the display.

According to one embodiment, the device interposed on the display interface bus is of the system-in-package or system-on-chip type mounted on an interconnection support of the terminal.

According to one embodiment, the display interface bus is a MIPI-DSI bus.

According to one embodiment, the secure element is configured to present an active operating mode and an inactive operating mode, and to, in the inactive mode, connect the display to the display controller of the application processor so that the display is managed by the application processor, and in the active mode, connect the display to the output of the second display controller so that the display is exclusively managed by the secure element, display information relating to a transaction initiated by an application executed by the application processor, then perform cryptographic calculations necessary for completing the transaction, and the device further comprises a transaction validation device actionable by a user and exclusively accessible by the secure element, allowing the user to validate the transaction based on the transaction-related information displayed by the secure element, before the secure element performs the cryptographic calculations.

According to one embodiment, the terminal further comprises an input device controlled by a corresponding bus, and a demultiplexer controlled by the secure element, the secure element being configured to in the inactive mode, connect the input device bus to the application processor, and in the active mode, connect the input device bus to the secure element.

According to one embodiment, the input device is a touchscreen and the transaction validation device is a virtual button on the touchscreen in the active mode.

According to one embodiment, the transaction validation device is a physical button.

According to one embodiment, the secure element is configured to, during the execution of transaction steps assigned to it, inhibit circuits or components of the device that could serve an attacker to obtain information about actions performed by the user or calculations performed by the secure element, such as an accelerometer, an inertial measurement unit, a camera, a current sensor, a voltage sensor, or other component that could allow an attacker to conduct a side-channel attack.

According to one embodiment, the terminal further comprises a dedicated visual indicator, exclusively controlled by the secure element and activated by the secure element in the active mode and deactivated by the secure element in the inactive mode.

According to one embodiment, the terminal further comprises a physical bistable switch actionable by the user and exclusively accessible by the secure element, the secure element being configured to enter the active mode when the bistable switch is in a first position and enter the inactive mode when the bistable switch is in a second position, and means for prompting the user to actuate the switch.

Embodiments also concern a method for executing a transaction using a terminal as described above, comprising the steps of: initializing the transaction using an application executed by the application processor; with the switch being in the inactive mode position, prompting, using the application and a message on the display, that the user toggle the switch to the active mode position; upon switching, sending an acknowledgment to the application by the secure element; upon reception of the acknowledgment, transmitting transaction information to the secure element by the application; using the secure element, displaying the transaction-related information, waiting for transaction validation by the user then performing the cryptographic calculations necessary for completing the transaction, then sending a result of said calculations to the application; and using the secure element, prompting via a message on the display that the user toggle the switch to the inactive mode position.

Embodiments also concern a method for integrating a crypto asset hardware wallet in a connected terminal comprising an application processor having a first display controller connected to a display interface bus carrying display data formatted according to a display interface bus protocol, and a display connected to the display interface bus and designed to receive display data formatted according to said protocol. The method comprises the steps of providing and interposing on the display interface bus a device comprising a secure element, a second display controller exclusively controlled by the secure element, designed to provide display data formatted according to said protocol, and a multiplexer controlled by the secure element and comprising a first input, a second input, and an output, connecting the secure element to the application processor by a secure wired bus, connecting the first input of the multiplexer to an output of the first display controller via the display interface bus, connecting the second input of the multiplexer to an output of the second display controller, and connecting an output of the multiplexer to the display via the display interface bus, the multiplexer output providing display data formatted according to said protocol to the display.

According to one embodiment, the device interposed on the display interface bus is of the system-in-package or system-on-chip type mounted on an interconnection support of the terminal.

According to one embodiment, the display interface bus is a MIPI-DSI bus.

According to one embodiment, the method comprises the steps of configuring the secure element to present an active operating mode and an inactive operating mode; when the secure element is in the inactive mode, connecting the display to the display controller of the application processor so that the display is managed by the application processor; when the secure element is in the active mode, connecting the display to the output of the second display controller so that the display is exclusively managed by the secure element; and providing a transaction validation device actionable by a user and exclusively accessible by the secure element, allowing the user to validate the transaction based on the transaction-related information displayed by the secure element, before the secure element performs the cryptographic calculations.

According to one embodiment, the method further comprises the steps of providing an input device controlled by a corresponding bus, and a demultiplexer controlled by the secure element, and the steps of, when the secure element is in the inactive mode, connecting the input device bus to the application processor, and when the secure element is in the active mode, connecting the input device bus to the secure element.

According to one embodiment, the method comprises the steps of providing a physical bistable switch actionable by the user and exclusively accessible by the secure element, switching the secure element to the active mode when the bistable switch is in a first position, switching the secure element to the inactive mode when the bistable switch is in a second position, and prompting the user to actuate the switch to switch the secure element to the active mode or to the inactive mode.

### BRIEF DESCRIPTION OF THE DRAWINGS

Embodiments will be described in the following description of non-limiting examples in relation to the attached figures among which:

FIG. 1 illustrates conventional examples of using a hardware wallet through a host device;

FIG. 2 illustrates a conventional hardware wallet architecture;

FIG. 3 is a partial block diagram of a first embodiment of a mobile terminal or other connected device embedding a hardware wallet;

FIG. 4 is a block diagram of a first embodiment of a connected terminal defeating a first type of fraud that could target a terminal of the type of FIG. 3;

FIG. 5 is a block diagram of a second embodiment of a connected terminal defeating the first type of fraud that could target a terminal of the type of FIG. 3;

FIG. 6 is a block diagram of an embodiment of a connected terminal defeating a second type of fraud targeting a terminal of the type of FIG. 5;

FIG. 7 is a block diagram of an embodiment of a connected terminal in which the use of an embedded secure element is under user control; and

FIG. 8 illustrates a component arrangement of a connected mobile terminal according to one of FIGS. 4 to 6.

### DETAILED DESCRIPTION

As indicated above, an aim is to integrate a hardware wallet into a connected terminal (smartphone or other connected device) while avoiding attacks made possible due to this configuration. To avoid creating an entirely new ecosystem and not harm the user experience, compatibility with existing hardware and operating systems (Android, iOS) is also sought, as well as using traditional application distribution channels. Such mobile terminals may therefore install and execute applications that may come from unknown, or even dubious sources, which increases the challenge of securing transactions with the embedded hardware wallet.

It is therefore assumed that installable applications can gain access to hardware resources involved in communication with a secure element implementing the hardware wallet.

Generally, official applications of the concerned services, particularly financial services (banks, cryptocurrencies), are certified and signed and are more difficult to modify with malicious code. When they are loaded for execution, the signature verification fails if they have been modified. However, malicious software can deduce certain interactions of the official application with the hardware and modify the inputs and outputs of the official application.

For example, it is possible that malicious software records pressed keys to steal a secret code, simulates pressed keys to falsify a transaction, modifies the display to deceive the user about the transaction they are executing.

More specifically, the validation of a transaction on a phone by a virtual keyboard can be intercepted by a low-level spyware having access to the touchscreen interface by detecting the coordinates of touches on the touchscreen. Without knowing what is displayed, the spyware may rely on the assumption that the displayed virtual keyboard is one of the many traditional keyboards available on the platform, so that the touch coordinates reveal the keyboard keys. The spyware may also have access to accelerometers or other sensors typically present in a mobile terminal-touches at different positions on the screen translate into different acceleration values in rotation on two axes, so that touch positions can be deduced.

To partially remedy this, applications display, for personal identification code entry, a numeric virtual keyboard with randomly positioned keys. However, although this measure is useful for hindering the deduction of an identification code, it does not prevent malicious software from deducing that a transaction is in progress and, before the user has finished, modifying the amount or recipient and simulating validation (modifications of the application's inputs without modifying the application itself).

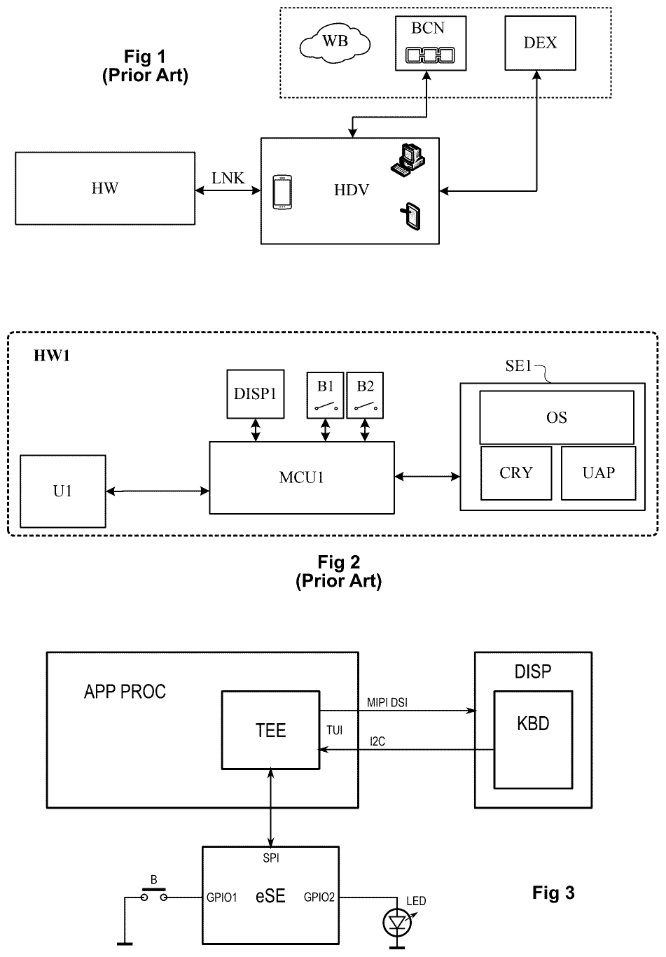

FIG. 3 represents a partial block diagram of a first embodiment of a mobile terminal or other connected device embedding a hardware wallet.

The mobile terminal integrates an application processor APP PROC connected to various peripheral devices, particularly a touchscreen including a display DISP and a touchpad KBD. The processor manages the display through a dedicated display interface bus, often a MIPI DSI bus. The processor manages the touchpad through another interface, generally I2C. For clarity, not all elements of a mobile terminal are shown.

When the mobile terminal is designed to perform secure transactions, like most mobile terminals today, the application processor generally integrates a secure enclave or trusted execution environment TEE. Such an enclave generally includes a processor, memory and a display manager or display controller DC1 for managing a touchscreen. It is designed to implement a trusted user interface TUI, for example as recommended by the “Trusted User Interface API” document from GlobalPlatform® (See references in Appendix). Thus, this enclave can, according to instructions executed by the application, manage the display DISP and input on the touchpad KBD, as shown.

Such an enclave is distinct from a secure element typically used in hardware wallets, and does not alone provide a sufficient degree of security for blockchain-managed crypto asset transactions. Indeed, since hardware wallets can provide access to very high values in crypto assets, the means employed by hackers are commensurate with the value they can extort.

According to the embodiments described here, the mobile terminal also includes an embedded secure element eSE implementing a hardware wallet. The element eSE may be similar to that integrated in detached hardware wallets, also called cold hardware wallets, described previously. It may be an STMicroelectronics® ST33 microcontroller which has, among other things, a secure serial peripheral interface SPI, two I2C interfaces and various programmable input/output pins GPIO. The link designated by LNK in FIG. 1 between the mobile terminal HDV and the detached hardware wallet HW, generally a USB or Bluetooth interface, is here implemented by a permanent wired connection between the secure element eSE and the application processor via the SPI interface. To ensure better communication security, the connection may be managed by the TEE enclave, as shown.

The implementation of the hardware wallet function in the element eSE and the exchanges between the element eSE and the processor APP PROC may be entirely similar to what is known from FIG. 1, considering by analogy that the secure element here forms the detached wallet HW of FIG. 1 and that the application processor here forms the host device HDV of FIG. 1.

Furthermore, one of the input/output pins GPIO1 is connected to a physical button B designed to validate transactions through a mechanical operation. The pin GPIO1 is exclusively managed by the secure element and its state change is impossible to simulate by software executed on the application processor. Another input/output pin GPIO2 controls an indicator LED to signal that a secure operation is in progress with the hardware wallet in the element eSE. The button B is a dedicated physical button arranged, for example, on a lateral wall of the mobile terminal, which is visually distinct from other buttons typically provided on the mobile terminal. The indicator LED is also dedicated and conspicuous compared to other light indicators typically provided on the mobile terminal.

With this configuration, a transaction is prepared in the usual way by an official application, such as “Ledger Live”, executed on the application processor. From the moment when the user must validate the transaction, the application passes through the enclave TEE to display the transaction on the display DISP and, if applicable, manage an input phase on the touchpad KBD, such as entering an identification code to unlock the secure element. The validation and signing of the transaction are delegated to the element eSE by commands issued on the SPI bus through the enclave TEE. If applicable, the inputted unlock code is transmitted to the secure element via the SPI bus. The element eSE responds to these commands by activating the indicator LED and waiting for a press on button B.

When button B is pressed, the element eSE calculates the transaction signature with the private keys stored in the wallet and transmits the signature to the application via the SPI bus. The secure element, having completed its task, deactivates the indicator LED and waits for new commands. The application updates the blockchain through a network service, displays useful information, and waits for new user interaction.

If no action is detected on the button after a timeout, the transaction is canceled. The secure element signals this to the application via the SPI bus, deactivates the indicator LED, and waits for new commands.

Button B has a similar function to the buttons B1, B2 of a detached hardware wallet of the type shown in FIG. 2. Malicious software, if it manages to modify the amount or address of the transaction, will not be able to simulate a validation, which requires the actuation of a physical button detectable only by the element eSE. Thus, the user, before validating, can confirm that the transaction as displayed is indeed the one they initiated. If the transaction has been modified, the user can in principle notice it on the display and cancel the transaction. The cancellation may be performed conventionally by pressing a virtual button on the touchscreen. The cancel button function cannot be hijacked into a validation function, since validation is only possible using the physical button B managed exclusively by the element eSE.

The indicator LED reassures the user that the secure element is handling the operations and that, in principle, the requests made to it are from a trusted source.

According to a variant slightly more costly in terms of manufacturing the mobile terminal housing, two physical buttons could be provided that must be pressed simultaneously to validate a transaction, as is done with detached hardware wallets.

Now, more sophisticated malicious software, as previously indicated, could modify the input and/or output data of the application to hijack them. For example, the malicious software could intercept transaction data entered in the application to replace them (such as the amount and address). Even if this is difficult when input is performed in secure mode using the enclave TEE, it is not impossible given the degree of security offered by a conventional TEE enclave. The application would then generate a transaction with falsified data that it would communicate to the element eSE. To prevent the user from noticing the falsification by observing the displayed transaction data, the display itself could be controlled by the malicious software, even if this is difficult, so that the displayed data corresponds to the transaction initially desired by the user. Thus, the user would see apparently correct transaction data and validate the transaction, but this validation would operate on the fraudulently modified transaction that has been stealthily delegated to the element eSE.

In a conventional detached hardware wallet, this type of fraud is thwarted by the fact that the wallet has its own display and presents the essential characteristics of the transaction on this display: the user relies on the information displayed by the detached hardware wallet, and can compare it to that displayed by the application on the terminal. Such functionality is not feasible when the hardware wallet is embedded in a connected terminal of smartphone type or equivalent, given the difficulty of providing a second screen and the additional cost this would entail.

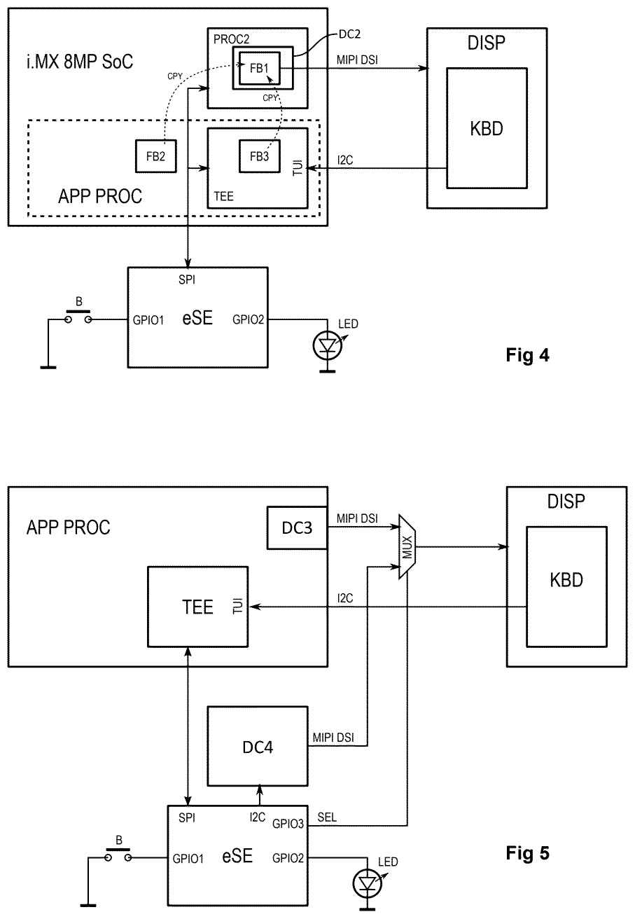

FIG. 4 is a block diagram of a first embodiment of a mobile terminal integrating a hardware wallet and defeating this type of display manipulation.

Compared to FIG. 3, the processor APP PROC is associated with a secondary processor PROC2. The processor PROC2 has its own display controller DC2. In an embodiment, the application processor APP PROC has, like previously, a TEE enclave and the processor PROC2 has a command set allowing it to control the enclave TEE via an SPI bus. In an embodiment, the application processor APP PROC and the processor PROC2 are integrated into a system-on-chip SoC, for example the i.MX 8M Plus circuit from NXP®.

The display controller DC2 of processor PROC2 controls the MIPI DSI bus of the display DISP using a frame buffer FB1 that processor PROC2 can fill from the content of a frame buffer FB2 of the application processor, from the content of a frame buffer FB3 of the enclave TEE (arrows CPY) if such an enclave is provided, or from display data received through another channel or generated internally, as needed.

In another embodiment, processor PROC2 directly displays data from memory FB2 or FB3 using a pointer that has been provided to it. The display mechanisms are documented and will not be described in more detail. Generally, regardless of the chosen embodiment, processor PROC2 is designed to be the master of the MIPI DSI bus in the sense that it can decide which data it provides to the display, depending on their origin.

Thus, according to the needs of a running application, display DISP receives display data from the application processor, the enclave TEE, or the secondary processor PROC2 itself. Since display controller DC2 is controlled by processor PROC2, processor PROC2 can choose the information that will be transmitted to display DISP in order to display information it deems has priority according to its configuration.

In this embodiment, the element eSE is connected by the SPI bus to processor PROC2, with the aim of managing the display according to the methods described below, and processor PROC2 is configured via software to give priority to display commands issued by the element eSE.

Furthermore, touchpad KBD may still be managed by the enclave TEE for secure input, but other control modes will be described later, applicable to this embodiment.

With this configuration, a transaction is prepared in the usual way by an official application, such as “Ledger Live”, executed by the processor APP PROC. The application delegates the processing of sensitive transaction steps to the element eSE, via the bus SPI, for example steps during which the user must validate the transaction and where the transaction must be signed using a private key of a crypto asset account held by the element eSE. The application may also use the enclave TEE, if provided, for example if an unlock code input is required.

Regarding the display of transaction-related information for validation by the user, the display data produced by the application can, as in FIG. 3, be transmitted to the display controller DC2 via the frame buffer FB3 of the enclave TEE or the frame buffer FB2 of the application processor, which are then filled with the corresponding graphical data and whose content is then transferred to the frame buffer FB1 of the display controller DC2.

In parallel, the element eSE, having itself received the transaction data, transmits display data via the bus SPI to processor PROC2 for display via its display controller FB1 instead of the data that would be present in frame buffers FB2 and FB3.

If incidentally the transaction display data produced by the application are compromised by malicious software, these data end up in frame buffer FB2 or FB3, but they are ignored, because it is the data produced by the element eSE in frame buffer FB1 that are actually displayed.

In such an embodiment, processor PROC2 thus plays the role of a kind of software multiplexer, because it is configured via software to give priority to display data provided by the secure element. For this reason, processor PROC2 is preferably configured in hardware and/or software to offer a high degree of security. In hardware, processor PROC2 is preferably “walled” from other circuits with which it communicates, similar to a secure element, to reduce its attack surface. In particular, the number of hardware connections between processor PROC2 and other circuits, for example connections with processor APP PROC and enclave TEE, may be reduced to a minimum to prevent an attack on these elements from allowing control of processor PROC2 to be taken. Schematically, this minimum hardware connectivity may rely on the fact that connections between processor APP PROC and processor PROC2 are reduced to those that allow processor APP PROC to transfer the content of frame buffer FB2 to processor PROC2. Similarly, hardware connectivity between enclave TEE and processor PROC2 may be reduced to just the SPI bus, through which the content of frame buffer FB3 is transferred to frame buffer FB1. Processor PROC2 may also execute software protected against various known attacks.

FIGS. 5, 6 and 7 show other embodiments of a mobile terminal integrating a hardware wallet, also defeating display manipulation by malicious software, and offering a solution compatible with multiple chipsets available for smartphones. In these embodiments, the display data conveyed on the display interface bus connected to display DISP, here, as previously, a MIPI DSI bus, are controlled by the element eSE. Thus, the latter can decide to inject its own display data on the MIPI DSI bus while preventing those provided by the application processor from reaching the display. Such “injection” of display data by the element eSE is done through a routing in the form of a multiplexer MUX controlled by the element eSE. The multiplexer MUX receives on a first input the display data provided by processor APP PROC and on a second input display data provided by the element eSE. The output of the multiplexer is directly connected to the display to which it provides display data in MIPI DSI format, which are either those provided by the application processor, or those provided by the secure element.

Such an architecture based on display control by the secure element, using hardware multiplexing of a low-level bus, here MIPI DSI, conveying display data in a format directly usable by the display, minimizes the attack surface of all components of the connected terminal.

In particular, security problems are avoided that would result from placing, at the multiplexer output, a display controller that would convert into MIPI DSI data the unformatted data (or data formatted according to another protocol) provided by the multiplexer. Such a display controller would be exposed to attacks, particularly software attacks, aimed at corrupting the data it provides to the display. Such a display controller could also, if it were connected to the application processor and the secure element by a common control bus (for example a bus carrying synchronization signals), offer a significant attack surface to fraudsters through this control bus.

Thus, the solution proposed here, which involves switching low-level display signals (i.e., not requiring transformation before being provided to the display) allows avoiding this type of attack.

In the embodiment of FIG. 5, the MIPI DSI bus of display DISP is thus connected to the output of multiplexer MUX. The multiplexer receives on a first input the display data in MIPI DSI format produced by display controller DC3 of processor APP PROC, formatted according to the MIPI DSI protocol. Alternatively, these data could be provided by a display controller of enclave TEE, which has not been shown. But in practice these display data no longer need to be managed by enclave TEE, as shown. Indeed, a second input of the multiplexer receives display data in MIPI DSI format generated by a display controller DC4 exclusively managed by element eSE, allowing secure display of sensitive information. An input/output pin GPIO3 of element eSE is programmed to provide to the multiplexer a signal SEL for selecting the first or second input of the multiplexer. The SEL signal could also be taken from pin GPIO2 that controls indicator LED.

Display controller DC4 receives display commands from element eSE, for example via the I2C bus. The I2C bus offers relatively low data throughput, but this bus is used to carry only textual and vector display commands, using low bandwidth. Element eSE is thus programmed to generate basic display commands for the transactions it processes and transmit them to the display controller.

Display controller DC4 is here a separate circuit, since secure element chips commonly available do not have one or do not have sufficient bandwidth to generate the bitmap images expected on the bus of a display such as that of a modern smartphone.

While waiting for a transaction signature request, element eSE controls multiplexer MUX to send to display DISP the MIPI DSI format display data from the application processor.

When an application executed by processor APP PROC delegates a transaction signature to element eSE, the latter sends the transaction data display commands to display controller DC4 and switches multiplexer MUX so that the MIPI DSI format data produced by display controller DC4 reach display DISP. The indicator LED is activated and element eSE waits for validation by button B.

With this configuration, display DISP presents the transaction data actually received by element eSE. If they have been modified from the initial intention, the user will see it and can cancel the transaction.

It is of course preferable that any unlock code entries or other sensitive information used for managing element eSE present a security level at least equal to that of the display.

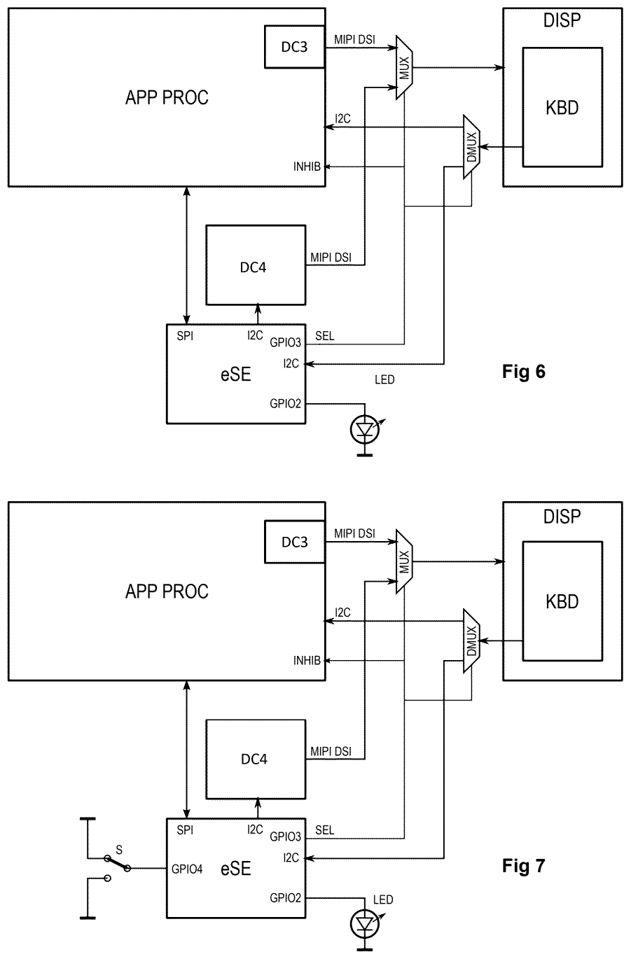

FIG. 6 is a block diagram of an embodiment of a mobile terminal using element eSE instead of enclave TEE to manage touchpad KBD, and raising the security level to that of a secure element. Compared to FIG. 5, the I2C output bus of touchpad KBD is connected to a router in the form of a demultiplexer DMUX whose first output is connected to processor APP PROC and a second output is connected to the I2C interface of element eSE. The demultiplexer DMUX selection may be operated by the same signal SEL as multiplexer MUX. In this structure, physical validation button B is optional, as will be understood below. Furthermore, enclave TEE is no longer required and is no longer shown.

While waiting for transaction processing, element eSE positions multiplexer MUX and demultiplexer DMUX to connect display DISP and touchpad KBD to the application processor, in a traditional configuration.

Since the touchscreen escapes application control during delegation to the secure element, the application can no longer implement the user input phase. Thus, the user input phase is also delegated to the secure element, which is for the occasion programmed to manage a virtual keyboard for user input and display.

When a transaction is delegated by the application to the secure element via bus SPI, this time without passing through enclave TEE, element eSE switches the multiplexer and demultiplexer to connect display DISP and touchpad KBD respectively to display controller DC4 and element eSE. Element eSE implements the user input phase, if input is required (providing an unlock code). Input on the touchpad can no longer be intercepted or modified by software running on the application processor, while any attempt to modify the display by software running on the application processor is ignored.

Given this configuration, software running on the application processor cannot simulate false validations on the touchscreen, so physical button B is optional; furthermore validation can also be done securely using the touchpad.

The securing of touchpad KBD has been described starting from the structure of FIG. 5, but it is applicable to the structure of FIG. 4 where, in secure mode, touchpad management is switched to the secure element instead of enclave TEE.

According to an embodiment, the signal SEL, or any other secure mode indicator (like the control signal of indicator LED), is used to inhibit circuits or components normally unused during secure mode, and that could serve an attacker to obtain information about actions performed by the user or calculations performed by element eSE, such as an accelerometer, an inertial measurement unit, a camera, a current sensor, a voltage sensor, or other component that could allow an attacker to conduct a side-channel attack, or the application processor itself.

The signal SEL is connected, for example, to a pin INHIB used to halt the application processor. A halt can be achieved by activating a processor reset input, cutting off its clock signal, or cutting off its power supply. In this case, any malicious software running on the application processor performing analyses to deduce cryptographic keys or other sensitive information is rendered inoperative during the secure transaction.

Total inactivation of the application processor is possible in a configuration, for example that of FIG. 6, where all functions that must remain active during the transaction are moved to element eSE.

If it is not possible or desired to deactivate the application processor, the signal SEL may be used to deactivate auxiliary components or circuits that could be used to deduce sensitive information that could allow a side-channel attack. For example, information provided by accelerometers allows deducing touchpad touch positions. Accelerometers are generally integrated into a dedicated inertial measurement unit or IMU circuit. Such an inertial measurement unit may be deactivated by stopping its clock, cutting off its power supply or cutting off its communication link with the application processor, generally an I2C bus.

Malicious software may be designed to initiate transactions when element eSE is in a configuration where it does not request an unlock code, for example during a limited time after performing a previous transaction. The malicious software attempts to modify the display, but this attempt fails because element eSE is the master of the display in FIGS. 5 and 6. Thus, the display reflects the transaction actually initiated by the malicious software, while element eSE waits for user validation on the touchpad (in the configuration of FIG. 6), or on physical button B (in the configuration of FIG. 4 or 5). In the case of FIG. 3, fraudulent modification of the display is possible, so the user could be deceived about the nature of the transaction.

If the fraudulent transaction is initiated at a time when the user has the mobile terminal in view, the user sees, without having requested it, the terminal go into secure mode (LED indicator), display the transaction and request validation. The user can verify the display and cancel the transaction, but this requires the user to be focused and not validate the transaction by mistake.

If the user does not have the mobile terminal in view, the transaction is in principle automatically canceled when the timeout period expires. However, if the mobile terminal is subjected to jolts in a pocket or bag, an unintended validation could occur before the timeout period expires, either by pressing physical button B (FIGS. 3 to 5), or by pressing the touchpad (FIG. 6) which could be configured to be operational on the mobile terminal's lock screen when requesting validation.

FIG. 7 is a block diagram of an embodiment of a mobile terminal defeating this type of fraud. The aim here is to simulate in some way the connection and disconnection operation of a conventional detached wallet to its host device, namely establishing or breaking the connection between the detached wallet and its host device, for example a Bluetooth or USB connection. In addition to the elements of FIG. 6, a physical bistable switch S is connected to link an input/output pin GPIO4 of element eSE to a low logic level in a first position, and to a high logic level in a second position. Switch S is arranged, for example, on one of the lateral walls of the mobile terminal.

Element eSE is programmed to be silent to commands received via bus SPI (inactive mode) in one of the positions of switch S, for example in the first position, and accept transactions via bus SPI (active or secure mode) in the other position. The terminal is designed so that switch S is the only means available to switch the element's mode, meaning that an application can no longer by itself delegate transaction processing.

Thus, the secure element's mode is exclusively under user control who chooses the mode using switch S according to needs.

With switch S initially in the inactive mode position, an application likely to initiate transactions is then designed to prompt the user to change modes when it is about to delegate transaction processing to element eSE. It can send to display DISP a message like “Please put the phone in secure mode using the switch”, preferably with information about the ongoing transaction. This message is analogous to a message inviting the user to connect their conventional detached wallet to the mobile terminal.

The user then toggles the switch to enter active mode. Element eSE responds by taking various protective measures, such as toggling the signal SEL to connect display DISP to display controller DC4 and connect touchpad KBD to element eSE. Indicator LED is also activated to signal to the user that the mobile terminal is in secure mode. Element eSE sends an acknowledgment to the application which resumes execution by transmitting the transaction information to element eSE. Element eSE operates the user input phase on touchpad KBD, if applicable, and requests validation from the user by displaying the transaction information again.

When the transaction is validated and signed, element eSE communicates the signed transaction to the application which records it on the blockchain. Element eSE prompts the user to change modes, by sending to display DISP a message like “Please exit secure mode by toggling the switch”. This message is analogous to one indicating that the user can remove their conventional detached wallet. When the switch is toggled, the initial connections of the display and touchpad are restored, and indicator LED is deactivated.

Switch S can also be implemented in the structures of FIGS. 4 and 5, where touchpad KBD is not connected to element eSE. In this case, it is the application that operates the user input phase before requesting the toggling of switch S.

Of course, switch S, at the user's mercy, could be toggled at times when it is not required, or not toggled when required. Various combinations are thus not “normal”, and this can be signaled to the user through displayed messages or alarms, encouraging the user to toggle the switch so operations can resume normally.

Malicious software could also behave like an official application by requesting a mode change. However, since the user has not initiated the transaction and is being asked for a relatively constraining action, the user is likely to be more vigilant. The malicious software can no longer display a misleading off-topic message, since the user expects to see transaction information. Such transaction information will be difficult to make credible, especially if it is true-typically a transfer of a large amount to an unknown address. If the malicious software attempts to hide the nature of the transaction, it will be revealed and different when it is displayed for validation by element eSE, if the user has nevertheless been tempted to switch to secure mode.

In any case, a pending transaction, whether fraudulent or not, can no longer be validated by an unintended press on a physical or virtual button, because the user must intentionally switch the mobile terminal to secure mode to validate the transaction.

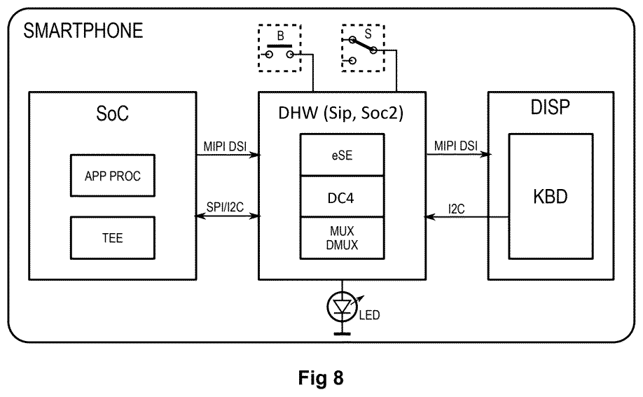

FIG. 8 illustrates a component layout of a mobile terminal (smartphone) according to one of FIGS. 4 to 6. The aim here is to be able to “graft” a hardware wallet functionality into a conventional mobile terminal platform to transform it into a mobile terminal with an embedded hardware wallet.

In the conventional mobile terminal, processor APP PROC and potentially its enclave TEE can be implemented as a system-on-chip SoC. The SoC includes pins soldered to respective tracks of a printed circuit board or other interconnection support receiving a number of other components. Respective groups of pins are associated with different communication links between components, in particular the MIPI DSI, SPI and I2C buses previously mentioned.

Furthermore, display DISP and touchpad KBD are generally external and parallel to the printed circuit board. Their different control buses are then connected to the printed circuit board by connectors soldered to tracks on the printed circuit board.

The various elements described above for implementing an embedded hardware wallet, chosen from elements eSE, DC4, MUX, DMUX, and connectors for all or part of elements B, S and LED according to the chosen embodiment, are implemented in the form of a device DHW integrated into the conventional mobile terminal platform. Device DHW can be a system-in-package SiP designed to be mounted on a printed circuit board, or form another SoC (SoC2).

To adapt device DHW to the conventional mobile terminal platform and thus achieve the integration of an embedded hardware wallet, space is arranged on the printed circuit board to solder device DHW, the latter being for example in SiP form, the tracks of the different buses used are re-routed by interrupting them so that they pass through device DHW, and tracks are routed to establish the SPI bus between processor APP PROC and element eSE.

The different discrete physical elements managed by the circuits of the SiP (button B, switch S, indicator LED) can be fixed to the terminal's housing and connected to connectors of the SiP, or to connectors offset on the printed circuit board, themselves connected by tracks to dedicated pins of the SiP.

It should be noted that such integration of device DHW into a conventional mobile terminal is considerably simplified by the fact that multiplexer MUX is interposed directly on the MIPI DSI bus connecting processor APP PROC to display DISP, which allows intercepting the unsecured flow of image data provided by the application processor to substitute it with the secure flow of image data provided by display controller DC4 of element eSE. Thus, no reverse decoding of MIPI DSI format image data is necessary, nor is providing a display controller at the output of multiplexer MUX to provide MIPI DSI format image data.

With this configuration, a conventional mobile terminal can be transformed into a mobile terminal with an embedded hardware wallet by simply adding device DHW in SiP package or as a SoC, on a printed circuit board carrying the conventional terminal components. Although designing the adapted printed circuit board represents a certain development and production cost, this cost remains negligible because there is no adaptation required at the level of the conventional terminal hardware platform.

It should be noted that MIPI DSI is currently the display interface bus standard most generally used between a mobile terminal display controller and a display peripheral. It will be apparent to those skilled in the art that the ideas and principles just described in relation to integrating a hardware wallet into a mobile terminal may be applied if another type of display interface bus than MIPI DSI is used, if applicable.

It will also be apparent to those skilled in the art that the embodiments just described are susceptible to various alternatives depending on technology evolution. In particular, although element eSE has been described above as being associated with a distinct display controller DC4 to which it is connected via an I2C bus, it is not excluded that a secure element might in the future integrate such a display controller DC4.

The preceding description has been written essentially in the context of smartphones embedding a hardware wallet for signing transactions on the blockchain (“blockchain smartphones”). However, the described principles apply to any type of connected terminal (to the Internet or a local network) storing secrets used for various purposes involving cryptographic calculations, such as signing transactions in general and authentication, including “zero knowledge” authentication. In other types of connected terminals, the human-machine interface may be a display associated with a physical keyboard, or a joystick.

1. A connected terminal comprising:
an application processor having a first display controller connected to a display interface bus conveying display data formatted according to a protocol of the display interface bus,
a display connected to the display interface bus and designed to receive display data formatted according to said protocol;
a device interposed on the display interface bus, the device comprising:
a secure element connected to the application processor by a secure wired bus,
a second display controller exclusively controlled by the secure element, designed to provide display data formatted according to said protocol, and
a multiplexer controlled by the secure element and comprising a first input connected to an output of the first display controller via the display interface bus, a second input connected to an output of the second display controller, and an output connected to the display via the display interface bus the multiplexer output providing display data formatted according to said protocol to the display,
wherein the terminal is configured to, in the context of performing a transaction initiated by an application executed by the application processor and during execution of steps of the transaction assigned to the secure element:
halt the application processor so that it is totally inactive, or
inhibit circuits or components of the device that could serve an attacker to obtain information about actions performed by a user or calculations performed by the secure element, such as an accelerometer, an inertial measurement unit, a camera, a current sensor, a voltage sensor, or other component that could allow an attacker to conduct a side-channel attack.

2. The terminal according to claim 1, wherein the device interposed on the display interface bus is a system-in-package or system-on-chip mounted on an interconnection support of the terminal.

3. The terminal according to claim 1, wherein the display interface bus is a MIPI-DSI bus.

4. The terminal according to claim 1 wherein the secure element is configured to present an active operating mode and an inactive operating mode, and to:
in the inactive mode, connect the display to the display controller of the application processor so that the display is managed by the application processor, and
in the active mode, connect the display to the output of the second display controller so that the display is exclusively managed by the secure element, display information relating to a transaction initiated by an application executed by the application processor, then perform cryptographic calculations necessary for completing the transaction,
the device further comprising a transaction validation device actionable by a user and exclusively accessible by the secure element, allowing the user to validate the transaction based on information related to the transaction displayed by the secure element, before the secure element performs the cryptographic calculations.

5. The terminal according to claim 4, further comprising:
a user input device controlled by a corresponding bus, and
a demultiplexer controlled by the secure element,
the secure element being configured to:
in the inactive mode, connect the user input device bus to the application processor, and
in the active mode, connect the user input device bus to the secure element.

6. The terminal according to claim 5, wherein the user input device is a touchpad and the transaction validation device is a virtual button on the touchpad in the active mode.

7. The terminal according to claim 4, wherein the transaction validation device is a physical button.

8. The terminal according to claim 4, further comprising a dedicated visual indicator, exclusively controlled by the secure element and activated by the secure element in the active mode and deactivated by the secure element in the inactive mode.

9. The terminal according to claim 4, further comprising:
a physical bistable switch actionable by the user and exclusively accessible by the secure element, the secure element being configured to enter the active mode when the bistable switch is in a first position and enter the inactive mode when the bistable switch is in a second position, and
means for prompting the user to actuate the switch.

10. A method for executing a transaction using a terminal according to claim 9, the method comprising the steps of:
initializing the transaction using an application executed by the application processor,
with the switch being in the inactive mode position, prompting the user, using the application and a message on the display, to toggle the switch to the active mode position;
upon toggling the switch, sending to the application, by the secure element, an acknowledgment to the application;
upon reception of the acknowledgment, transmitting to the secure element, by the application, information about the transaction;
using the secure element, displaying the information related to the transaction, waiting for validation of the transaction by the user, then performing the cryptographic calculations necessary for completing the transaction, then sending a result of said calculations to the application; and
using the secure element, prompting the user via a message on the display to toggle the switch to the inactive mode position.

11-17. (canceled)
